(19) United States
(12) Patent Application Publication
(10) Pub. No.: US 2022/0066410 A1
(43) Pub. Date: Mar. 3, 2022

(54) Sequenced Approach For Determining Wafer Path Quality

(71) Applicant: PDF Solutions, Inc., Santa Clara, CA (US)

(72) Inventors: Tomonori Honda, Santa Clara, CA (US); Richard Burch, McKinney, TX (US); Jeffrey Drue David, San Jose, CA (US)

(73) Assignee: PDF Solutions, Inc., Santa Clara, CA (US)

(21) Appl. No.: 17/459,657

(22) Filed: Aug. 27, 2021

Related U.S. Application Data
(60) Provisional application No. 63/071,981, filed on Aug. 28, 2020.

(51) Int. Cl. G05B 19/18; G05B 19/406

(52) U.S. Cl. CPC G05B 19/188; G05B 2219/45031; G05B 19/406

(57) ABSTRACT

Wafer quality is determined by modeling equipment history as a sequence of events, then evaluating anomalous results for individual events. Identifying an event that generates bad wafers narrows the list of possible root causes.

### CROSS REFERENCE

This application claims priority from U.S. Provisional Application No. 63/071,981 entitled Event Sequence Driven Approach to Determine Quality of Wafer Path for Semiconductor Applications, filed Aug. 28, 2020, and incorporated herein by reference in its entirety.

### TECHNICAL FIELD

This application relates generally to determination of root cause(s) for semiconductor wafer excursions, and more particularly, to identifying particular sequences of processing that are linked to production of off-quality wafers.

### BACKGROUND

The determination of a root cause for a semiconductor production problem is a well-known but difficult issue. Systems for classification and anomaly detection typically rely upon analysis of extensive data obtained from production runs to evaluate data excursions from expected values. It would be desirable to have effective tools for narrowing the scope of possible causes to thereby simply classification schemes.

In this disclosure, the transitions from one step to another (or one piece of equipment to another) in a fabrication facility are evaluated to identify those transitions, and in particular, pairs of transitions, that are critical for distinguishing classes of wafers, most simply, good wafers or bad wafers.

### DESCRIPTION OF DRAWINGS

FIG. 1 is block diagram illustrating a processing paths for a portion of a semiconductor process.

FIG. 2 is a graphical plot of true positive results vs. false positive results for example step transition data.

### DETAILED DESCRIPTION

This disclosure describes an approach that is useful in determining root cause(s) for semiconductor wafer production quality issues. The approach models semiconductor processing equipment history for wafer or lot production as an event sequence. Probabilities are then computed for each transition between steps or states of a particular semiconductor recipe as the wafer/lot moves from equipment to equipment or chamber to chamber, namely, is this transition likely to lead to good wafers or bad wafers? The computed probabilities for the complete wafer processing path are aggregated and cross-validated to confirm the accuracy of the model.

Because it is common to provide multiple processing paths for selected steps of a process, such as providing multiple lithography chambers that feed multiple etching chambers, it has been recognized that such paired combinations can produce differing quality results. Thus, the objective is to identify a particular sequence of processing steps that accounts for more bad or off-quality wafers/lots than another sequence. This objective can be achieved by returning to the individual probabilities to find and evaluate anomalous transitions. This information will narrow the field of possible root causes, and for that reason, will be an important input for determining root cause.

Of course, a typical semiconductor process may have hundreds of steps to form the desired circuit features, including deposition, diffusion, ion implantation, lithography, etch, metallization, etc., and upon completion of the device, post-fabrication testing. In addition, as noted above, it is common to provide multiple parallel processing paths for selected steps of the recipe. However, having multiple processing paths creates the opportunity for differing quality results, which will be evaluated as shown here.

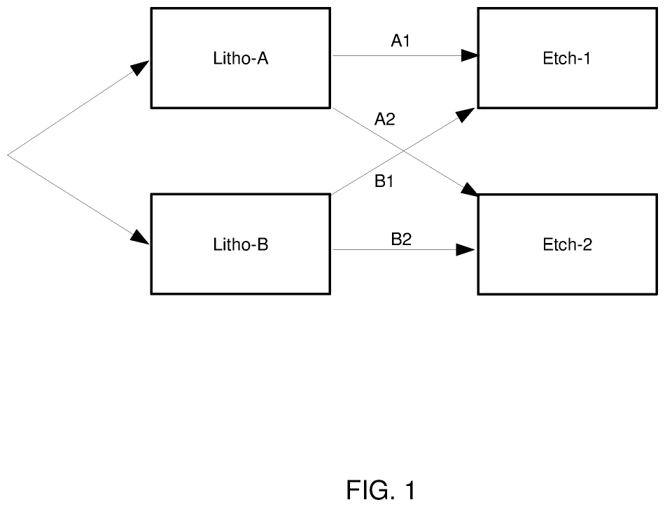

Referring now to FIG. 1, consider as an example a small portion of a semiconductor recipe where there are two possible lithography steps, Litho-A and Litho-B, that feed to a corresponding pair of etching steps, Etch-1 and Etch-2. That is, wafers from Litho-A may be directed along a first path A1 to Etch-1 or a second path A2 to Etch-2, and likewise, wafers from Litho-B may be directed along a first path B1 to Etch-1 or a second path B2 to Etch-2.

In this example, assume that final results from a current production run of this recipe show that 90% of the wafers that are processed along path A1 are acceptable good quality while 10% turn out to be off-quality; conversely, only 10% of the wafers that are processed along path A2 are acceptable good quality, while 90% of the wafers processed along path A2 turn out to be off-quality. Thus, we clearly now know that most of the off-quality wafers come from path A2, while most of the good quality wafers come from path A1. This conclusion indicates that some interaction between Litho-A and Etch-2 is problematic and should be identified and corrected to improve yield. For example, there may be a slight misalignment of the mask in the Litho-A operation that does not severely impact the quality of the wafer after processing in Etch-1. However, the misalignment in Litho-A may be propagated and further impacted by an additional misalignment in the etching step, and the combination of misalignments in Litho-A and Etch-2 cause the wafer to fail quality testing. Identifying path A2 as the culprit narrows the list of possible causes for off-quality wafers to lithography-related issues in Litho-A, etch-related issues in Etch-2, and the transport of wafers from Litho-A to Etch-2.

Thus, a model can be created to evaluate the probabilities at each transition from one step of the process to another step for a particular process path. The transition probabilities are then aggregated to check the performance of the model. If the model produces results that match the production results, then the individual probabilities of each process step can be reviewed to identify the process paths (as event sequences) that lead to anomalous results.

The model can be based on known classification and anomaly detection models for event sequences, including but not limited to a Naïve Bayes classifier, a Markov chain (MC), a hidden Markov model (HMM), and a recurrent neural network (RNN), and is trained on production data from that process path.

As a high-level example, a machine learning model is configured based on a Markov chain stochastic model to evaluate transitions from one state to the next state, the state transition representing a step in the wafer processing path from one piece of equipment (or chamber) to the next piece of equipment (or chamber) in the processing recipe.

The model is generalized by an example of a using a portion of a processing path that proceeds through state i to state j and then on the path to some final state k. For example, equation (1) below computes a fraction T^{good lot} of normal/good wafers that pass to state j from state i, as measured by metrology and other common statistical indicators. The fraction T^{good lot} is equal to the count of normal quality wafers that pass from state i to state j, divided by the sum of counts of normal quality wafers that pass from state i to the final state k.

$${T}_{{state}_{i} , {state}_{j}}^{goodlot} = \frac{{CNT}_{{state}_{i} , {state}_{j}}^{goodlot}}{{\sum }_{{state}_{k}} {CNT}_{{state}_{i} , {state}_{k}}^{goodlot}} \qquad ( 1 )$$

Similarly, equation (2) below computes a fraction T^{bad lot} of off-quality/bad wafers that pass to state j from state i. The fraction T^{bad lot} is equal to the count of off-quality wafers that pass from state i to state j, divided by the sum of counts of off-quality wafers that pass from state i to state k.

$${T}_{{state}_{i} , {state}_{j}}^{badot} = \frac{{CNT}_{{state}_{i} , {state}_{j}}^{badlot}}{{\sum }_{{state}_{k}} {CNT}_{{state}_{i} , {state}_{k}}^{badlot}} \qquad ( 2 )$$

The final prediction W for each wafer lot is the sum of log-odd transitions, as shown in equation (3) below. The more positive the final prediction W, the more likely it is that the entirety of the processing path leads to normal quality wafers. The more negative the final prediction W, the more likely it is that the processing path leads to off-quality wafers.

$${W}_{k}^{MC} = log ( \frac{{T}_{{state}_{k 1}^{0}}^{goodlot}}{{T}_{{state}_{k 1}^{0}}^{badlot}} ) + {\sum }_{j = {state}_{k 2}}^{{state}_{k ( N - 1 )}} log \frac{{T}_{j , j + 1}^{goodlot}}{{T}_{j , j + 1}^{badlot}} \qquad ( 3 )$$

For processing paths that produce more negative results, equation (2) provides a quantification of off-quality at each step along the path, and can be reviewed and analyzed to identify significant fractions T^{bad lot} that require investigation for corrective action. As noted above, by identifying anomalous transitions, the list of possible causes becomes more limited and very likely known as a result. Further, the results of computations from each transition can be provided as inputs to a hierarchical model configured for determining root cause.

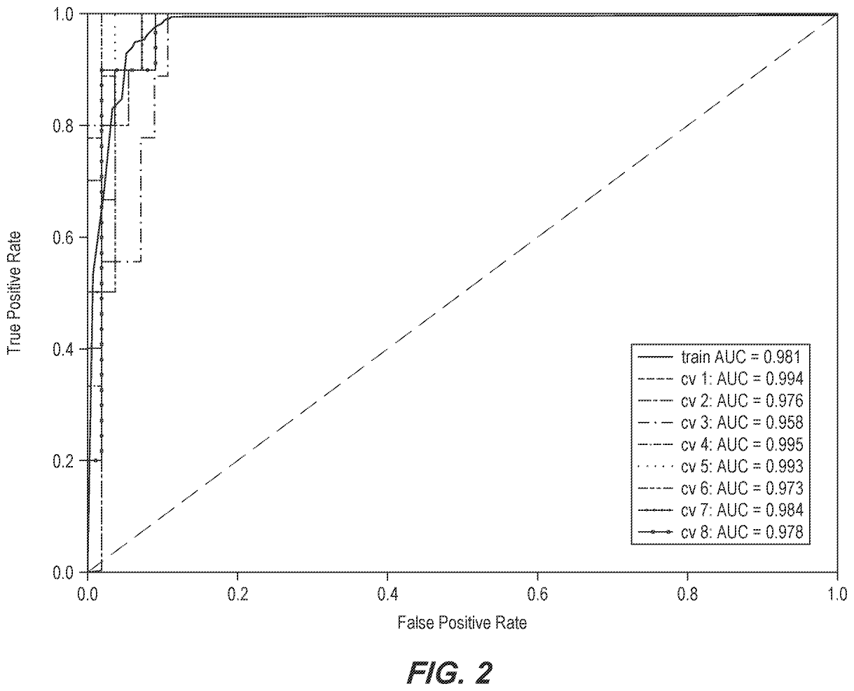

Example data for a prediction Won a training set is shown in FIG. 2, where the area under the ROC curve (AUC) is graphed with a true positive rate is plotted on the y-axis, namely, the model prediction for a good wafer is accurate, versus a false positive rate plotted on the x-axis, namely, the model prediction for a good wafer is not accurate. The data set is put through a k-fold cross validation, with the training set plotted as well as each validation result plotted as cv1, cv2 . . . cv8. From these results, it can be seen that the sets cv1, cv4 and cv5 produce true positive rates exceeding 99% and would be good candidate to use as the model implementation.

This is a promising result for identifying the problematic equipment chains. For example, the model detects that when the wafer goes through a particular sequence of equipment processing, such as equipment A to equipment B to equipment C in that order, the wafer has a statistically significant increase in probability that it will be a bad wafer. This knowledge of sequence and transition probabilities will help customer identify the likely root cause for the bad wafer. Outputs from the model can be provided as inputs to a second model configured for root cause determination, where the equipment-history based inputs can provide significant predictive ability for root cause determinations. Outputs from the model can also be provided to a third model configured to improve the predictability of the first model, for example, through feature engineering and selection to limit inputs to those having a significant predictive ability.

The model needs to handle cases where there is uncertainty in the transition probability due to a small sample size. To do so, transitions that are not statistically significant are removed from the average transition probabilities. Further, a prefix can be added to all transition counts T. For example, the initial transition counts can be set as follows:

CNTₛₜₐₜₑ_{ᵢ}_{, state}_{ⱼ}^{good lot}=x (4)

CNTₛₜₐₜₑ_{ᵢ}_{, state}_{ⱼ}^{bad lot}=a*x (5)

where a is the ratio of bad lots to good lots. The transition probability can be recomputed when the model detects a significant change.

A hidden Markov model assumes a Markov model with unobservable hidden states. For this application, internal hidden states can be represented as wafer quality inputs, which produces observables such as intermediate Wafer Acceptance Test (WAT) or Process Control Monitoring (PCM) data, which are test measurements from test structures built in scribe lines and collected during manufacturing steps. Other possible inputs include, but are not limited to, defect data, metrology data, and FDC indicators. The transition probability for this hidden Markov model could be configured as dependent on different processing path scenarios, for example, based on the current equipment in use, the current manufacturing process step, or pairs of equipment (what was used previously and what will be used next), process step pairs, etc.

The modeling of transition probabilities is facilitated by the emergence of parallel processing architectures and the advancement of Machine Learning algorithms which allow users to model problems and gain insights and make predictions using massive amounts of data at speeds that make such approaches relevant and realistic. Machine Learning is a branch of artificial intelligence that involves the construction and study of systems that can learn from data. These types of algorithms, and along with parallel processing capabilities, allow for much larger datasets to be processed, and are much better suited for multivariate analysis in particular.

The creation and use of processor-based models for implementing classification and anomaly detection methods, including computing transition probabilities as described herein, can be desktop-based, i.e., standalone, or part of a networked system; but given the heavy loads of information to be processed and displayed with some interactivity, processor capabilities (CPU, RAM, etc.) should be current state-of-the-art to maximize effectiveness. Additionally, these computations are highly parallelizable in a map-reducing manner, i.e., the computations could run easily in Big Data ecosystems. In the semiconductor foundry environment, the Exensio® analytics platform is a useful choice for building interactive GUI templates. In one embodiment, coding of the processing routines may be done using Spotfire® analytics software version 7.11 or above, which is compatible with Python object-oriented programming language, used primarily for coding machine learning models.

The foregoing description has been presented for the purpose of illustration only—it is not intended to be exhaustive or to limit the disclosure to the precise form described. Many modifications and variations are possible in light of the above teachings.

1. A method, comprising:
analyzing an equipment history for a lot of semiconductor wafers produced in a plurality of processing steps as a sequence of events including a corresponding transition between each event;
for each transition between events, computing a first statistical indicator for good wafers and a second statistical indicator for bad wafers;
detecting a data excursion for at least a first transition wherein the first statistical indicator exceeds a first threshold or the second statistical indicator exceeds a second threshold; and
identifying a plurality of possible root causes for the data excursion based on a comparison of the first and second indicators for the first transition.

2. The method of claim 1 performed in a classification and anomaly detection model configured for analysis of event sequences.

3. The method of claim 2, further comprising:
providing the first transition and corresponding first and second indicators as inputs to a root cause model configured for root cause determination.

4. The method of claim 3, further comprising:
providing a plurality of transitions each having a corresponding detected data excursion and first and second indicators corresponding to respective transitions as inputs to the root cause model, the root cause model configured using hierarchical techniques for root cause determination.

5. A method, comprising:
obtaining an equipment history for a lot of semiconductor wafers produced in a plurality of processing steps; and
generating a first model of the equipment history for the lot as a sequence of a plurality of events including a transition between each event, each event corresponding to one of the plurality of processing steps, the model configured for:
detecting a data excursion having an indicator exceeding a threshold for at least one of the transitions between a sequential pair of the plurality of events; and
identifying a plurality of possible root causes for the data excursion based on the at least one transition and a pair of the processing steps that correspond to the sequential pair of the plurality of events.

6. The method of claim 5, further comprising:
providing the at least one transition and the corresponding indicator as inputs to a second model configured for root cause determination.

7. The method of claim 5, further comprising:
providing a plurality of transitions each having a corresponding data excursion and the corresponding indicators for respective transitions as inputs to a third model configured using hierarchical techniques for root cause determination.

8. The method of claim 5, the detecting step further comprising:
for each transition between a sequential pair of the plurality of events, computing a first transition probability for the respective transition passing bad wafers; and
identifying the at least one transition when the first probability corresponding thereto exceeds a threshold.

9. The method of claim 5, the detecting step further comprising:
for each transition between a sequential pair of the plurality of events, computing a second transition probability for the respective transition passing good wafers; and
identifying the at least one transition when the second probability corresponding thereto exceeds a threshold.

10. The method of claim 5, the detecting step further comprising:
for each transition between a sequential pair of the plurality of events, computing a first count of good wafers and a second count of bad wafers;
aggregating the first and second counts; and
identifying the at least one transition for a first count exceeding a first threshold.

11. The method of claim 5, the detecting step further comprising:
for each transition between a sequential pair of the plurality of events, computing a first count of good wafers and a second count of bad wafers;
aggregating the first and second counts; and
identifying the at least one transition for a second count exceeding a second threshold.

12. The method of claim 5, wherein the first model is a classification and anomaly detection model configured for analysis of event sequences.

13. The method of claim 12, wherein the first model is selected from a group consisting of a Naïve Bayes classifier, a Markov chain, a hidden Markov model, and a recurrent neural network.

14. The method of claim 13, wherein an output from the first model is input to a fourth model configured to improve predictability.

15. A non-transitory computer-readable medium having instructions which, when executed by a processor cause the processor to:
analyze an equipment history for a lot of semiconductor wafers produced in a plurality of processing steps as a sequence of events including a corresponding transition between each event;
for each transition between events, compute a first statistical indicator for good wafers and a second statistical indicator for bad wafers;
detect a data excursion for at least a first transition wherein the first statistical indicator exceeds a first threshold or the second statistical indicator exceeds a second threshold; and
identify a plurality of possible root causes for the data excursion based on a comparison of the first and second statistical indicators for the first transition.
